(19) United States
(12) Patent Application Publication
(10) Pub. No.: US 2005/0128149 A1
(43) Pub. Date: Jun. 16, 2005

(54) Antenna device

(76) Inventors: Carl-Gustaf Blom, Lysekil (SE); Elisabeth Wieslander, Lund (SE)

Correspondence Address: BACHMAN & LAPOINTE, P.C., 900 CHAPEL STREET, SUITE 1201, NEW HAVEN, CT, 06510, US

(21) Appl. No.: 10/498,886

(22) PCT Filed: Dec. 19, 2002
(86) PCT No.: PCT/SE02/02419

(30) Foreign Application Priority Data
Dec. 20, 2001 (SE) 0104348-8

(51) Int. Cl. H01Q 1/24

(52) U.S. Cl. 343/702

(57) ABSTRACT

An antenna device has at least one antenna element with two radiators disposed on a retainer member. The retainer member may be a separate unit but may also constitute an integral part of a casing for a cell or mobile telephone. In order to provide superior antenna performance and simple impedance adaptation, the radiators are connected in parallel and are designed so that they have a surface extent which is shaped to conform closely with the shape of interior surfaces of the casing. In one embodiment, there is an outer radiator which has a connecting portion which is located physically proximal the antenna element in order thereby to realize a capacitative/inductive connection of the outer radiator to the antenna element.

### BACKGROUND OF THE INVENTION

1. Technical Field

The present invention relates to an antenna device for a mobile radio communication apparatus, a so-called cell or mobile telephone, and designed for operation in at least two frequency bands, comprising at least a first antenna element connected to the circuits of the mobile telephone.

2. Background Art

The downsizing of mobile telephones has proceeded so far that the space available for the antenna of the mobile telephone is extremely limited. Further, among other things for aesthetic reasons, attempts have been made to avoid antennas which project outside the apparatus casing of the mobile telephone. This entails problems in antenna performance, on the one hand because the radiator components of the antenna are physically to the apparatus itself and, on the other hand, because they are also physically close to the head of the user.

One method of increasing antenna performance would be to employ telescopic rod antennas, but at least in the lower frequency bands that are employed in mobile telephony, even such a rod antenna designed as a quarter wave antenna would hardly have room interiorly inside the apparatus casing, since, for example, in the GSM band, an antenna length of approx. 80 mm would be required. Complex mechanical solutions would be called for to achieve the integration of such an antenna.

Many prior art antennas further have an impedance which greatly deviates from the 50 Ω, which is standard. This implies that matching networks must be employed between the antenna and the circuits of the mobile telephone, which is less desirable both with regard to cost and with regard to antenna performance.

### SUMMARY OF THE INVENTION

The present invention has for its object to design the antenna device intimated by way of introduction such that its performance may be drastically improved without the physical dimensions of the apparatus casing of the mobile telephone of necessity needing to be increased. The present invention further has for its object to realise an antenna device which obviates the drawbacks inherent in prior art technology. Finally, the present invention has for its object to realise an antenna device which is simple and economical in manufacture and which facilitates impedance adaptation to the circuits of the mobile telephone.

The objects forming the basis of the present invention will be attained if the antenna device intimated by way of introduction is characterised in that the first antenna element has at least a first and a second radiator of a surface extent which is shaped so as to comply with the configuration of an adjacent part of the inside of a casing in which the mobile telephone is accommodated.

### BRIEF DESCRIPTION OF THE DRAWINGS

The present invention will now be described in greater detail hereinbelow, with reference to the accompanying Drawings. In the accompanying Drawings:

FIG. 1 is, in perspective, an exploded view of a first embodiment of an upper part of a mobile telephone and a wrist strap or neck strap connectable thereto;

FIG. 2 is a perspective view corresponding to that of FIG. 1 with the components included in the assembled state;

FIG. 3 schematically illustrates the co-operation between the inner, permanent antenna of the mobile telephone and the outer antenna in a first embodiment;

FIG. 4 is a view corresponding to that of FIG. 3, but of a modified embodiment;

FIG. 5 is a view corresponding to that of FIG. 3, in yet a further modified embodiment;

FIG. 6 is a view corresponding to that of FIG. 3, but in still a further modified embodiment;

FIG. 7 is a perspective view of a second embodiment of an antenna device according to the present invention;

FIG. 8 is a second perspective view of the antenna device according to FIG. 7;

FIG. 9 shows a first alternative of the interconnection of two radiators included in the antenna device according to FIGS. 7 and 8;

FIG. 10 shows a second alternative of the interconnection of two radiators included in the antenna device according to FIGS. 7 and 8; and

FIG. 11 shows a third alternative of the interconnection of two radiators included in the antenna device according to FIGS. 7 and 8.

### DETAILED DESCRIPTION OF THE PREFERRED EMBODIMENT(S)

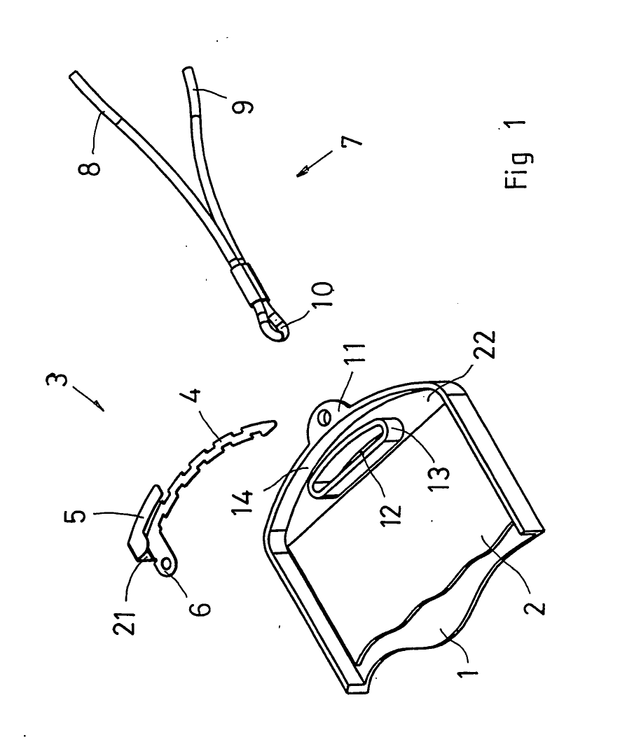

In FIG. 1, reference numeral 1 relates to an upper part of an apparatus casing for a cell or mobile telephone. This casing may be both an inner casing which, in such instance, is included in the mechanically bearing parts of the mobile telephone, and an outer casing which substantially fulfils aesthetic functions. Interiorly in this casing, there is disposed a circuit card 2 with the circuits of the apparatus. A first antenna element 3, which is in the form of an inner or permanent antenna 3, has two radiators 4 and 5, where, for example, the longer radiator, which is designed as a meander, may be dimensioned for GSM bands (880-960 MHz), while the shorter radiator 5 which, in the illustrated embodiment, is a rod antenna, may be dimensioned for the DCS- or PCS bands or both (1710-1880 MHz and 1850-1990 MHz, respectively).

Both radiators 4 and 5 are interconnected to each other by the intermediary of a connecting member 21 which realises a galvanic parallel connection of the radiators whereby the impedance is reduced to such a low level that a specific matching network may many times be dispensed with. The radiators have a common supply section 6 which is galvanically connected to the two radiators and further galvanically connected to the circuits on the circuit card 2. Between the two radiators 4 and 5, there is a dielectric such as air, glass, a suitable plastic material etc. The inner antenna 3 is dimensioned in order alone to be able to function satisfactorily, at least in environments where the reception conditions are good or normal.

The first antenna element 3 is disposed in or on and positionally fixed by means of a retainer device which, in this embodiment, is an integral part of the casing 1 of the apparatus. In the illustrated embodiment, the retainer device is formed by the inside 14 of the upper end wall of the casing 1 and a wall 13 projecting from the inside of the casing. In other words, the antenna element is interlockingly fixed in tight connection to the inside 14 of the casing.

In addition to the galvanic interconnection of the radiators 4 and 5, the connection 21 realises a separation of the radiators 4 and 5 so that, also in the longitudinal direction of the connecting member, they will be positioned closely adjacent inner surfaces, e.g. a rear surface 22 on the back portion of the casing 1.

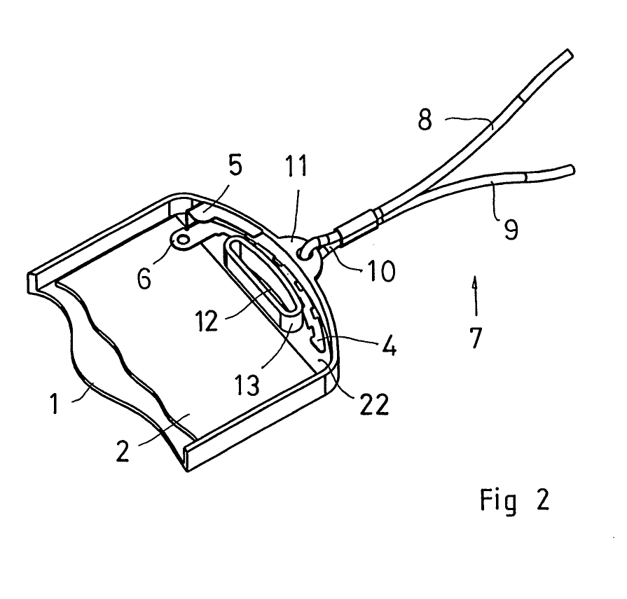

It will be apparent from FIGS. 1 and 2 that the two radiators 4 and 5 are arcuate in shape, whereby their shape is adapted to closely conform with the configuration of adjacent inner surfaces of the casing.

An outer antenna 7 is disposed on or together with or integral in a wrist strap, a neck strap or some similar accessory to the mobile telephone itself. The outer antenna 7 may therefore be seen as an accessory which greatly improves antenna performance, and which may be important in areas where reception conditions are less satisfactory. If, for purposes of exemplification of the outer antenna 7, we use a neck strap, this has a first part 8 and a second part 9 which are brought together in an eye 10 which is fixable in an anchorage 11 on the apparatus casing 1 physically close to the inner antenna 3. While not being apparent from FIG. 1, the outer antenna has a lightly flexible, metallic conductor whose dimensioning is such that, when, as a result of its physical proximity to the inner antenna 3, it is capacitatively/inductively connected to it and can operate with half wave operation in the frequency range to which the radiator 4 is set, up to full wave operation in the frequency range to which the radiator 5 is set. In one concrete example, the metallic conductor in the outer antenna 7 may be a thin, lightly flexible metal wire.

It is further apparent from FIGS. 1 and 2 that the apparatus casing 1 has, just beneath the anchorage 11, a through-going, elongate aperture 12 which, interiorly in the apparatus casing 1, is defined by the surrounding wall 13. Between the upper side of the surrounding wall 13 and the lower side or inside 14 of the apparatus casing, there is a space which, as was mentioned above, is dimensioned for mechanical retention of the inner antenna 3. FIG. 2 clearly shows how the antenna 3 is placed in this space and how it is shaped according to and follows the inner surfaces 14 and 22 of the casing 1. The through-going and elongate aperture 12 is also intended for the passage of an alternative to the neck strap with the parts 8 and 9, for example a wrist strap.

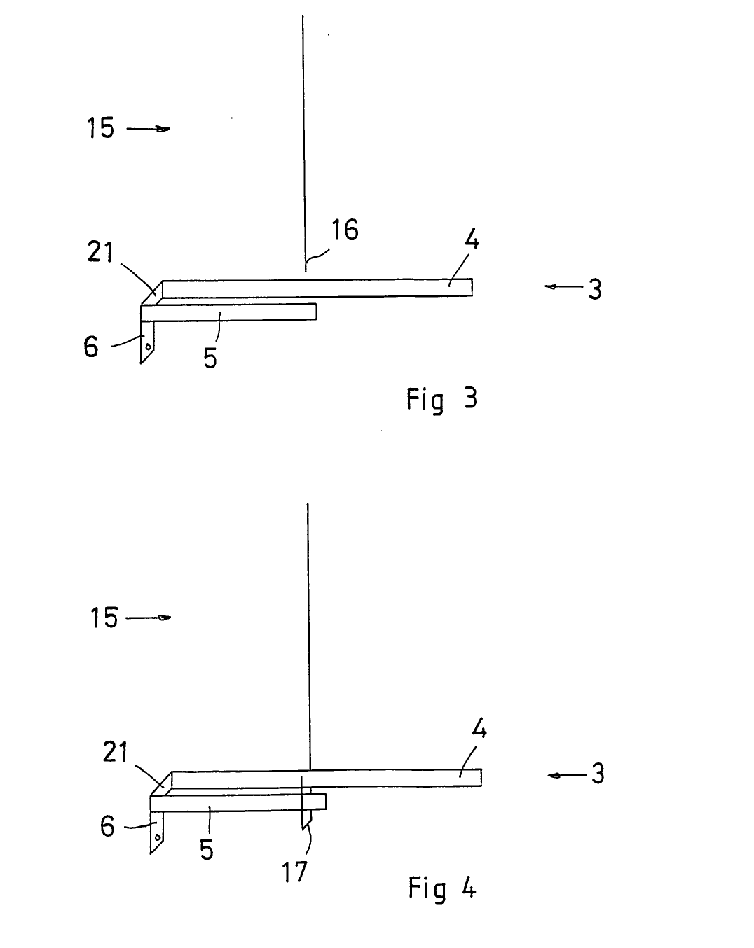

FIGS. 3 and 4 show one embodiment where there is disposed in the outer antenna 7, a single conductor 15 which constitutes a second antenna element if the inner antenna 3 is considered as a first antenna element. The conductor 15 has an end region or a coupling portion 16 which is located physically proximal the first antenna element. The distance between the coupling portion 16 and the first antenna element should be of the order of magnitude of 0.01-0.03 wavelengths. In FIGS. 1 and 2, the embodiment according to FIG. 3 has its counterpart in a situation where there is disposed in the outer antenna 7 a metallic conductor only in one of the two parts 8 and 9.

FIG. 4 shows a similar embodiment with a single conductor 15 which constitutes the second antenna element. In this embodiment, the coupling portion 17 has, however, a different appearance and extends at least partly about the first antenna element 3. In the embodiment according to FIGS. 1 and 2, this would imply that the neck strap or the wrist strap is passed through the through-going aperture 12 straight through the apparatus casing 1.

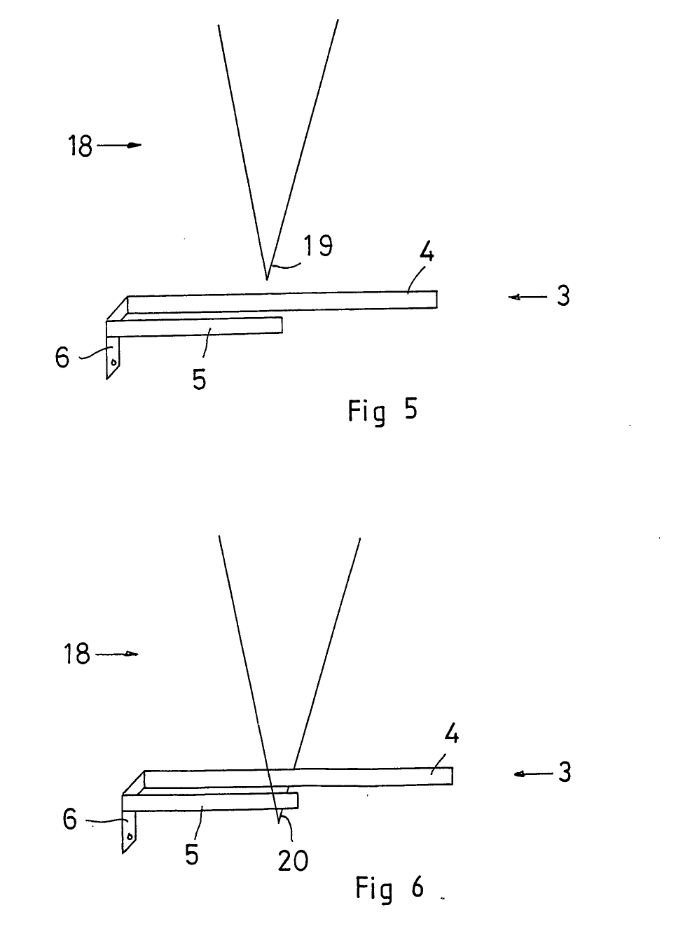

FIG. 5 shows an embodiment where a double or duplex conductor 18 is employed as the second antenna element. This has its counterpart in FIGS. 1 and 2 by the situation that both the first part 8 and the second part 9 of the neck strap or the wrist strap each have their part of the duplex conductor 18. The region of union between these parts constitutes the coupling portion 19 of the second antenna element. In FIGS. 1 and 2, this embodiment has its counterpart in a situation where the outer antenna 7 is secured in the anchorage 11 of the apparatus casing.

FIG. 6 shows a similar embodiment where the outer antenna 7 is secured in the through-going aperture 12 of the apparatus casing so that the coupling portion 20 of the second antenna element at least partly extends around the first antenna element.

In FIG. 1, the inner antenna, i.e. the first antenna element, has been shown as an antenna of sheet metal material produced, for example, by etching. This is not a critical requirement, but the inner antenna element 3 may be produced from a double-sided circuit card, a flexifilm secured on a suitably shaped carrier or vehicle of plastic or other suitable material, or a metalisation of the carrier, the retainer device or the inside of the casing. Further, the first antenna element may be a helical antenna which lies with its longitudinal direction approximately parallel with the width direction of the apparatus casing. Other configurations of the first antenna element are also possible.

According to the present invention, it is also possible to make the uppermost part of the apparatus casing 1 as a loose component which may be snapped in position on the rest of the apparatus casing. In such an embodiment, the counterpart to the anchorage 11 is located on this additional unit, this also accommodating the counterpart to the first antenna element.

A counterpart to the aperture 12 may be disposed either in the additional unit or in the joint between it and the apparatus casing proper, but possibly also in the apparatus casing itself. In addition to the first antenna element 3 interiorly in the additional unit, there may also be an additional antenna device interiorly in the apparatus casing.

In the embodiment according to FIGS. 1 and 2, the antenna element 3 is positionally fixed interiorly in the casing 1 by means of a retainer member which is designed as an integral part of the casing of the apparatus. In the described embodiment, the retainer member positionally fixes the antenna element by the intermediary of a mechanical, interlocking engagement. In another embodiment, where the retained member is an integrated part of the casing 1 of the apparatus, the radiators of the antenna element 3 are applied direct on interior surfaces in the apparatus casing 1. The radiators will hereby have a surface extent which is adapted to follow the configuration of these interior portions of the inside of the casing 1.

As a variation on this theme, a construction is conceivable where the radiators are disposed interiorly in the material of the casing.

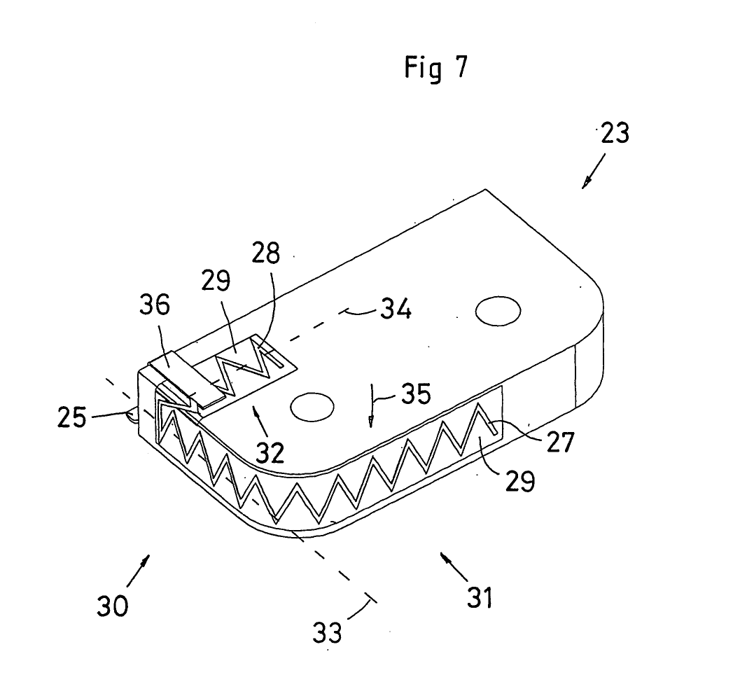

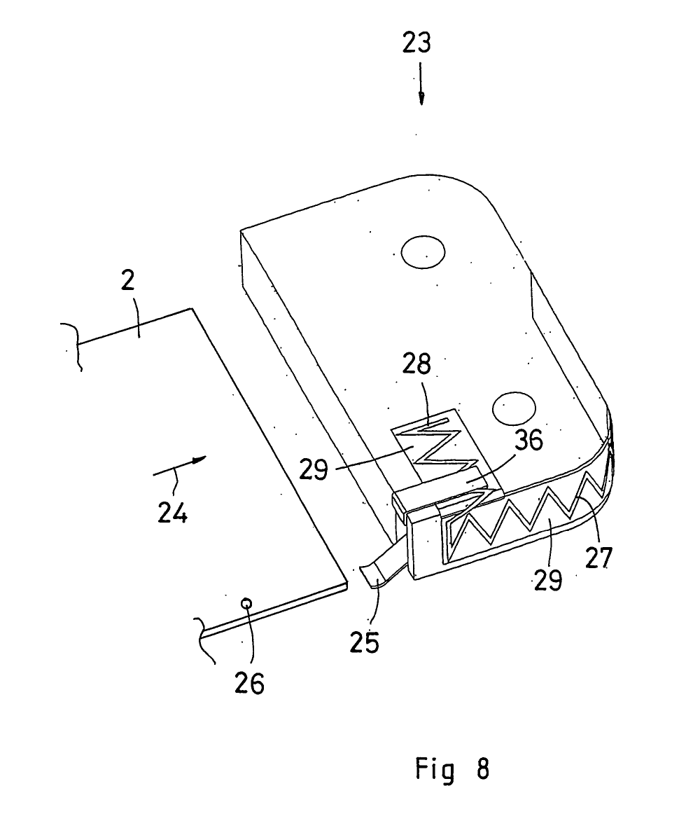

FIGS. 7 and 8 show one embodiment with a retainer member 23 which is designed as a separate unit which is insertable interiorly in the casing 1. The design of the retainer member 23 is such that at least parts of its surfaces connect to and are formed in accordance with adjacent, corresponding interior surfaces in the casing 1.

In the illustrated embodiment, the retainer member 23 (see FIG. 8) has an open interior in which a circuit card 2 may be insertable as is intimated by the arrow 24. As a result, the retainer member 23 and the circuit card 2 are joined to form a unit which is insertable interiorly in the casing 1.

It will further be apparent from the Figure that the retainer member 23 has a contact device 25 which is intended for contact with a corresponding contact device 26 on the circuit card 2. When the contact device 25 of the retainer member 23 is in communication with radiators 27 and 28 disposed on the retainer member, it will be seen that the radiators can, in a very simple manner, be connected to those circuits which are disposed on the circuit card 2.

The two radiators 27 and 28 are, in the illustrated embodiment, produced as meandering or zigzag shaped conductors which, in a practical embodiment, may be disposed on a flexifilm 29 disposed on the retainer member 23.

Of the two radiators 27 and 28 illustrated in FIGS. 7 and 8, the radiator 27 will also be designated a first radiator, while the radiator 28 will also be designated a second radiator.

The first radiator 27 has a first surface portion 30 and a second surface portion 31 which substantially lie in two separate planes that intersect one another possibly, as shown in the Figure, approximately at a right angle. The first surface portion 30 is disposed closely adjacent a side surface of the inside of the casing 1, while the second surface portion 31 is disposed closely adjacent an upper end surface 14 of the inside of the casing 1. The transitional region between the two surface portions 30 and 31 is an arched region, in the embodiment with the flexifilm 29, a single-arched region.

Correspondingly, the second radiator 28 has a surface portion 32 which substantially lies in a third plane that intersects the above-mentioned first and second planes, preferably as shown in the Figures at right angles.

The first portion 30 of the first radiator 27 is of a longitudinal extent which is intimated by a broken line 33, and the second radiator 28 is of a longitudinal direction which is intimated by the broken line 34. In the illustrated embodiment, these lines 33 and 34 make approximately a right angle with each other, but the present invention also encompasses embodiments where the second broken line 34 may be turned in accordance with the arrow 35 so that the angle between the two lines 33 and 34 is less than 90°, for example of the order of magnitude of 45°. By such a change of the embodiment, the second radiator 28 will be higher up, i.e. closer to the upper end of the mobile telephone and further away from its circuits.

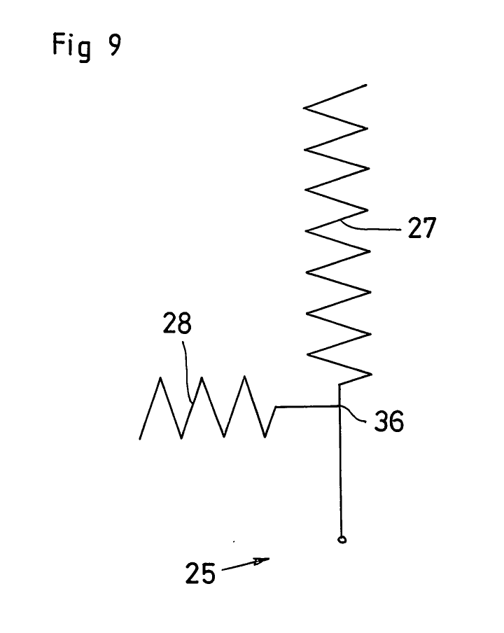

The contact device 25 has a supply section 36 which, in the embodiment illustrated in FIGS. 7 and 8, is connected to the ends of the two radiators 27 and 28. This alternative, which is a pure, galvanic parallel connection of the two radiators, is illustrated in FIG. 9.

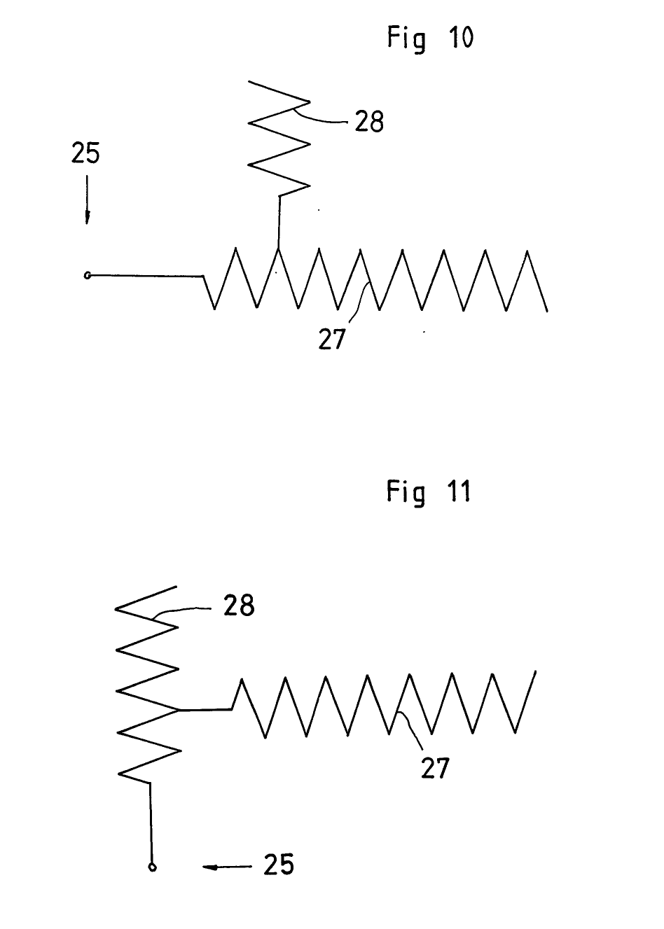

FIG. 10 shows an alternative interconnection of the two radiators 27 and 28 and it will be apparent that the first radiator 27 has its one end connected direct to the contact device 25, while the second radiator 28 has its supply end connected between the ends of the first radiator but preferably in the proximity of that end which is connected to the contact device 25.

FIG. 11 shows the reverse situation in relation to FIG. 10, where the second radiator 28 is connected directly to the contact device 25 with its one end while the one end of the first radiator 27 is connected to the second radiator 28 between both of its ends but preferably more proximal that end which is connected to the contact device 25.

In all of the embodiments illustrated in FIG. 7 to 11, both of the radiators 27 and 28 have one end free.

In those embodiments which are shown in FIGS. 7 to 11, the first radiator 27, i.e. the longer radiator, may be designed for a quarter wave resonance and a half wave resonance, for example quarter wave resonance in the GSM-band and half wave resonance in the DCS- or PCS-bands, while the second radiator 28, the shorter radiator, may be designed for quarter wave resonance in the DCS-band. If, in such instance, the settings in the DCS-band are not made exactly alike as regards the shorter and longer radiator, an increase of the band width will be attained in the higher frequency range.

1-18. (canceled)

19. An antenna device for a mobile radio communication apparatus and designed for operation in at least two frequency bands, comprising at least a first antenna element connected to circuits of a mobile telephone, the first antenna element having at least a first radiator and a second radiator and each radiator having a surface extent which is shaped so as to comply with a configuration of a closely adjacent portion of an inside of a casing in which the mobile telephone is accommodated.

20. The antenna device as claimed in claim 19, wherein the antenna element is disposed on or in a retainer member which is disposed to position the antenna element in relation to the portion of the inside of the casing.

21. The antenna device as claimed in claim 20, wherein the retainer member is provided as an integral part of the casing.

22. The antenna device as claimed in claim 20, wherein the casing, just beneath an upper defining wall, has a first wall projecting inwards in the casing; and the antenna element is positionally fixed in a space between an inside of the upper defining wall of the casing and the first wall.

23. The antenna device as claimed in claim 22, wherein the antenna element is disposed in a region immediately beneath the upper defining wall of the casing and has a longitudinal direction in a width direction of the casing.

24. The antenna device as claimed in claim 20, wherein the retainer member is provided as a separate unit insertable in the casing and has, at least on its surfaces provided with radiators and facing towards the inside of the casing, a design which conforms to a shape of the inside of the casing.

25. The antenna device as claimed in claim 24, wherein the antenna element includes at least two radiators, of which a first has a first surface portion and a second surface portion, said surface portions lying substantially in two discrete and separate planes that intersect one another, and of which a second radiator has a surface portion which substantially lies in a third plane intersecting the first and second planes.

26. The antenna device as claimed in claim 25, wherein the first, second and third planes are substantially at right angles to one another.

27. The antenna device as claimed in claim 26, wherein both radiators are meander- or zigzag shaped.

28. The antenna device as claimed in claim 25, wherein the first radiator has a substantially single curved portion between the first surface portion and the second surface portion.

29. The antenna device as claimed in claim 25, wherein the first radiator has a supply point at one end, while an opposite end is free; and that the second radiator has one end connected to the supply point and an opposite end is free.

30. The antenna device as claimed in claim 25, wherein the first radiator has a supply point at one end, while an opposite end is free; and that the second radiator has one end connected to the first radiator between the ends thereof, while an opposite end is free.

31. The antenna device as claimed in claim 25, wherein the second radiator has a supply point at one end, while an opposite end is free; and that the first radiator has one end connected to the second radiator between the ends thereof, while an opposite end is free.

32. The antenna device as claimed in claim 21, wherein the antenna element is disposed on a surface of the inside of the casing.

33. The antenna device as claimed in claim 21, wherein a second antenna element which, for the greater part, is disposed outside the casing and which has a connecting portion which extends through an aperture in the casing, to physical proximity with the first antenna element in order to be capacitatively/inductively connected thereto.

34. The antenna device as claimed in claim 33, wherein the second antenna element at least partly extends around the first antenna element with said connecting portion.

35. The antenna device as claimed in claim 33, wherein the connecting portion is an end portion of the second antenna element.

36. The antenna device as claimed in claim 33, wherein the connecting portion is a central portion of the second antenna element.
